(19) United States
(12) Patent Application Publication
(10) Pub. No.: US 2021/0283808 A1
(43) Pub. Date: Sep. 16, 2021

(54) MULTILAYER PREFORM INJECTION MOLDING

(71) Applicant: BROOQ PETROCHEMICAL COMPANY, Doha (QA)

(72) Inventor: Abdulrahman AL-THANI, Doha (QA)

(21) Appl. No.: 16/817,359

(22) Filed: Mar. 12, 2020

(51) Int. Cl. B29C 45/16; B29C 45/28; B29C 45/76

(52) U.S. Cl. CPC B29C 45/1684; B29C 45/2806; B29C 2945/76545; B29C 2945/76752; B29C 45/7613

(57) ABSTRACT

Methods and apparatuses for improving multilayer preform injection molding. The apparatus may be an apparatus for injection molding. The apparatus may include an injection unit, a first mold, a second mold, and a main runner. The apparatus may also include a sub-runner branched and connected from the main runner and feeds molten resin to a cavity. The apparatus may further include a main closing and opening unit configured to close and open the main runner. In addition, the apparatus may include a sub-closing and sub-opening unit configured to close and open the sub-runner.

### FIELD

Some embodiments may generally relate to injection molding. More specifically, certain embodiments may relate to an apparatus and method for multilayer preform injection molding.

### BACKGROUND

Injection molding is a manufacturing process for fabricating various components including plastic parts. A wide variety of products may be manufactured using injection molding, which may vary in size, complexity, and application. Further, injection molding may be performed with a variety of materials that may include metals, glass, elastomers, confections, and thermoplastic and thermosetting polymers.

The injection molding process may use an injection molding machine, raw plastic material, and a mold. During the injection molding process, the plastic may be melted in the injection molding machine and then injected into the mold. There, the melted plastic may cool and solidify into the final product. A conventional multi-injection machine may have multi-injection units that include a main injection unit and a sub-injection unit to inject two different types of resin. In particular, the main injection unit may inject a first resin, and the sub-injection unit may inject a second resin separately from the main injection unit.

Furthermore, in a general apparatus for injection molding a multilayer article, a conventional multi-injection machine may be needed. The multi-injection machine may include multi-injection units that include a main injection unit and a sub-injection unit. These injection units may inject two different types of resin. For instance, the main injection unit may inject a first resin and the sub-injection unit may separately inject a second resin.

According to conventional molding articles employing a conventional multi-injection machine, many injection units may unnecessarily be wasted due to the separate use of the main injection unit and the sub-injection unit. These injection units have their own separate runners as fluid paths, although the same runners may be used.

In view of the challenges with conventional injection molding machines, there is a need to provide an improved injection molding machine and procedure to minimize the number of injection units, and use of separate runners. There is also a need to improve the conventional multi-injection machine for injection molding a multilayer article in which an intermediary layer of barrier resin is disposed between layers of the same type of matrix resin, and to provide a hot runner apparatus for a multi-injection machine for injection molding a multilayer article in which an intermediary layer of barrier resin is disposed between layers of the same type of matrix resin.

### SUMMARY

One embodiment may be directed to an apparatus for injection molding. The apparatus may include an injection unit. The apparatus may also include a first mold including a first cavity to accommodate a first outer layer, a second cavity to accommodate a second inner layer, and an intermediary receiver to accommodate an intermediary layer. The apparatus may further include a second mold, and a main runner configured to feed molten resin into the first cavity. In addition, the apparatus may include a sub-runner branched and connected from the main runner and feeds the molten resin to the second cavity. Further, the apparatus may include a main closing and opening unit configured to close and open the main runner. In addition, the apparatus may include a sub-closing and opening unit configured to close and open the sub-runner.

Another embodiment may be directed to a method for injection molding. The method may include feeding molten resin into a first cavity of a first mold. The method may also include feeding the molten resin into a second cavity of the first mold. Further, the method may include inserting an intermediary layer into an intermediary receiver, and forming an injection molded multilayer container from the molten resin in the first cavity, the second cavity, and the intermediary receiver. In an embodiment, the molten resin may be fed into the first cavity through a main runner in a second mold. In another embodiment, the molten resin may be fed into the second cavity through connecting with a first sub-runner when both the first mold and the second mold are closed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates a side view of an injection molded multilayer container, according to an embodiment.

FIG. 2 illustrates a side sectional view of a hot runner apparatus 200 for injection molding a multilayer article, according to an embodiment.

FIG. 3 illustrates a side sectional view of an insert stage, according to an embodiment.

FIG. 4 illustrates a side sectional view of the first injection stage, according to an embodiment.

FIG. 5 illustrates a side sectional view of a second injection stage, according to an embodiment.

FIG. 6 illustrates a side sectional view of all three sub-valve pins in the closed position, according to an embodiment.

FIG. 7 illustrates a flow diagram of a method, according to an embodiment.

### DETAILED DESCRIPTION

It will be readily understood that the components of certain example embodiments, as generally described and illustrated in the figures herein, may be arranged and designed in a wide variety of different configurations. The following is a detailed description of some embodiments for synthesizing dry gels and the corresponding activated carbon gels using a thermal reaction to produce dry gels without the use of catalysts or non-water solvents.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

Certain embodiments may provide a hot runner apparatus for injection molding a multilayer article. Further, certain embodiments may implement injection molding a multilayer article without employing a conventional multi-injection machine in which many injection units are unnecessarily wasted due to the separate use of the main injection unit and the sub-injection unit, which have their own separate runners as fluid paths. As such, certain embodiments may lower the cost of injection molding a multilayer article wherein the first outer layer and the second inner layer may be the same type of matrix resin.

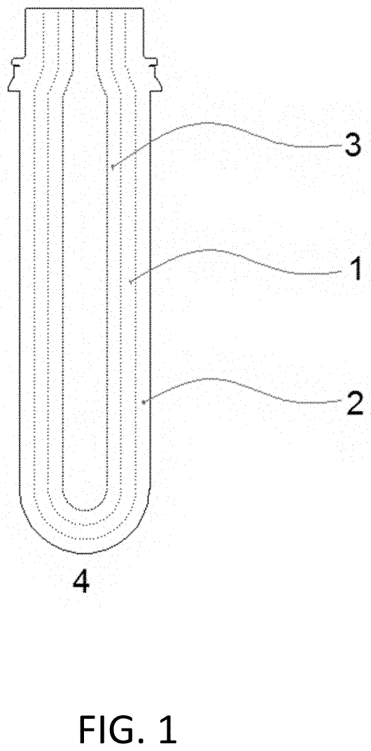

FIG. 1 illustrates a side view of an injection molded multilayer container, according to an embodiment. In particular, FIG. 1 illustrates an injection molded multilayer container to be carried out, according to an embodiment. As illustrated in FIG. 1, the injection molded multilayer container 4 may include an intermediary layer 1 disposed between the first outer layer 2 and the second inner layer 3. In an embodiment, the intermediary layer 1 may be of any suitable material, of which barrier resin material such as anti-UV and ethylene vinyl alcohol (EVOH) may serve as examples. In one embodiment, the first outer layer 2 and the second inner layer 3 may be of any suitable material, of which matrix resin such as polyethylene (PET) and polyethylene terephthalate glycol (PETG) may be some examples of the matrix resin.

FIG. 1 also illustrates a multilayer article in which an intermediary layer of a barrier resin is disposed between a first outer layer 2 and a second inner layer 3, according to one example. The first outer layer 2 and the second layer 3 may be composed of the same matrix resin. In the process of using the conventional multi-injection machine when injection molding a multilayer article such as that illustrated in FIG. 1, after inserting the intermediary layer 1 into the stationary mold, the moveable mold closes. Then, the main injection unit may inject the matrix resin into the movable mold, and the first outer layer 2 may be formed on one side of the intermediary layer 1. Following this procedure, the sub-injection unit may inject the matrix resin to form the second inner layer 3 on the opposite side of the intermediary layer 1.

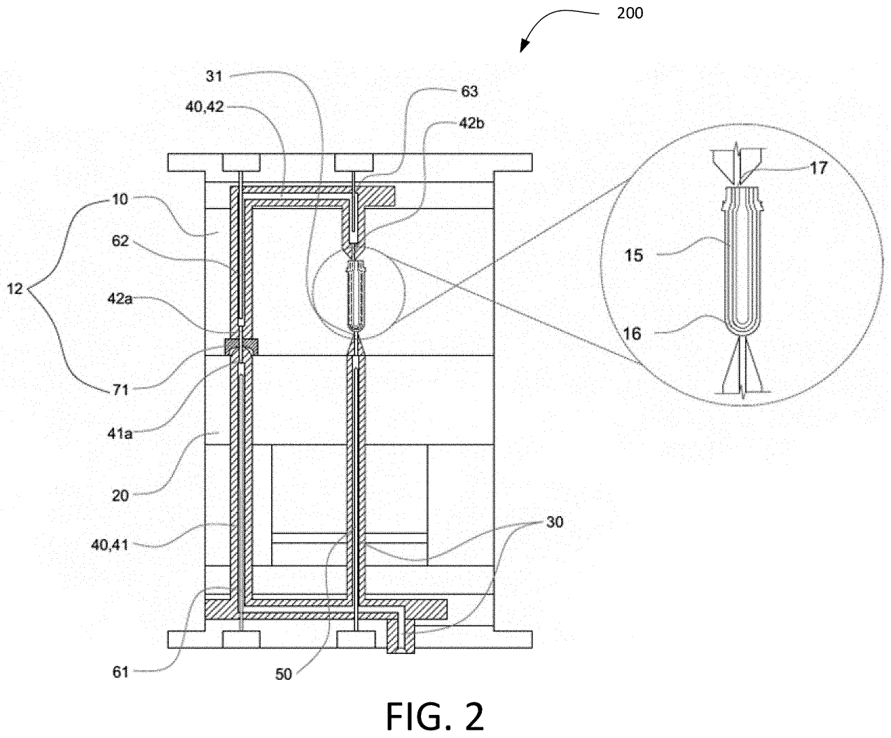

FIG. 2 illustrates a side sectional view of a hot runner apparatus 200 for injection molding a multilayer article, according to an embodiment. In particular, the hot runner apparatus 200 illustrated in FIG. 2 may be used for injection molding a multilayer container such as the multilayer container 4 illustrated in FIG. 1. According to an embodiment, the hot runner apparatus may include a mold. The mold may be composed of a first mold 10, a second mold 20, a first cavity 16 for the first outer layer 2, a second cavity 17 for the second inner layer 3. As illustrated in FIG. 2, reference 12 may correspond to a combination of the first mold 10, second sub-valve pin 62, inlet 42a, and locator 71. In one embodiment, the first cavity 16 and the second cavity 17 are formed in the first mold 10. In another embodiment, a main runner 30 feeds molten resin to the first cavity 16, and a sub-runner 40 is branched and connected from the main runner 30, and feeds the molten resin to the second cavity 17. According to another embodiment, a sub-closing and opening unit 60 closes and opens the sub-runner 40, and a control unit controls the main closing and opening unit 50 and the sub-closing and opening unit 60. In one embodiment, the control unit may include hardware such as, for example, at least one memory and at least one processor. The hardware may function with software stored in the memory to cause the control unit to perform various functions such as those described herein. In other embodiments, the sub-closing and opening unit 60 may include a combination of the first sub-valve pin 61, the second sub-valve pin 62, and the third sub-valve pin 63. In certain embodiments, these three pins may be operated separately by three separate and respective actuators.

According to certain embodiments, while the second mold 20 is fixed, the first mold 10 may move back and forth, thus opening and closing the mold accordingly. In one embodiment, while the first mold 10 closes the mold, the first cavity 16 and the second cavity 17 may be shut, and the matrix resin may be charged in the two cavities. While the first mold 10 opens the mold, molded multilayer container 4 may be released from the two cavities 16, 17. Further, the first mold 10 may include an intermediary receiver 15 into which an intermediary layer 1 may be inserted. In addition, the first cavity 16 may be formed on one side of the intermediary receiver 16 and the second cavity 17 may be formed on the opposite side of the intermediary receiver 15. As further illustrated in FIG. 2, the intermediary receiver 15, the first cavity 16, and the second cavity 17 may all be connected before the intermediary layer 1 is inserted into the intermediary receiver 15.

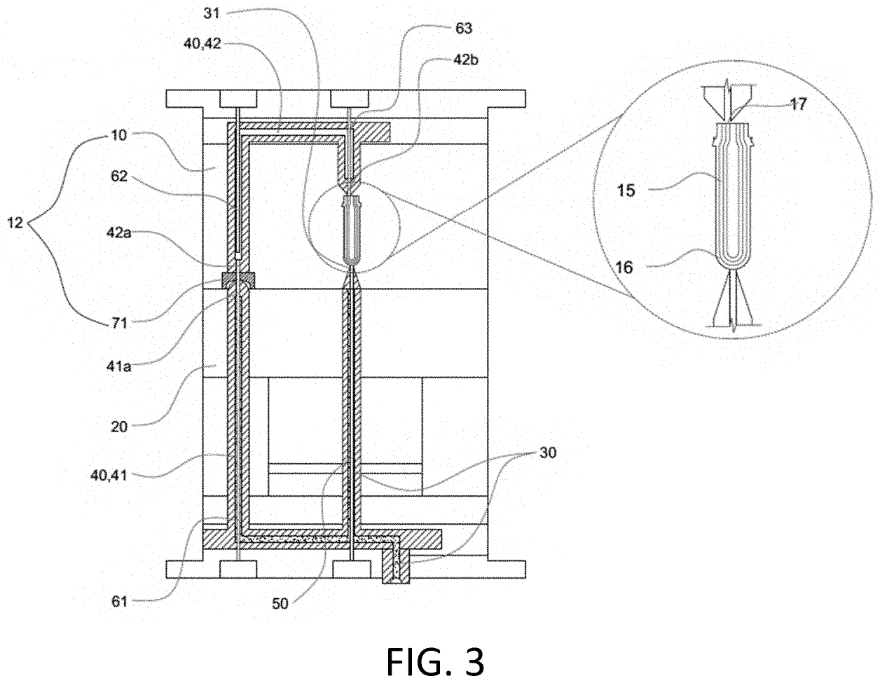

FIG. 3 illustrates a side sectional view of an insert stage, according to an embodiment. In particular, FIG. 3 illustrates an insert stage where the intermediary layer 1 is inserted into the intermediary receiver 15 before injection molding the first outer layer 2, and the second inner layer 3 is implemented. FIG. 3 also illustrates the insert stage of the hot runner apparatus 200, in which the intermediary receiver 15 partitions off and disconnects the first cavity 16 and the second cavity 17 after the intermediary layer 1 is inserted into the intermediary receiver 15.

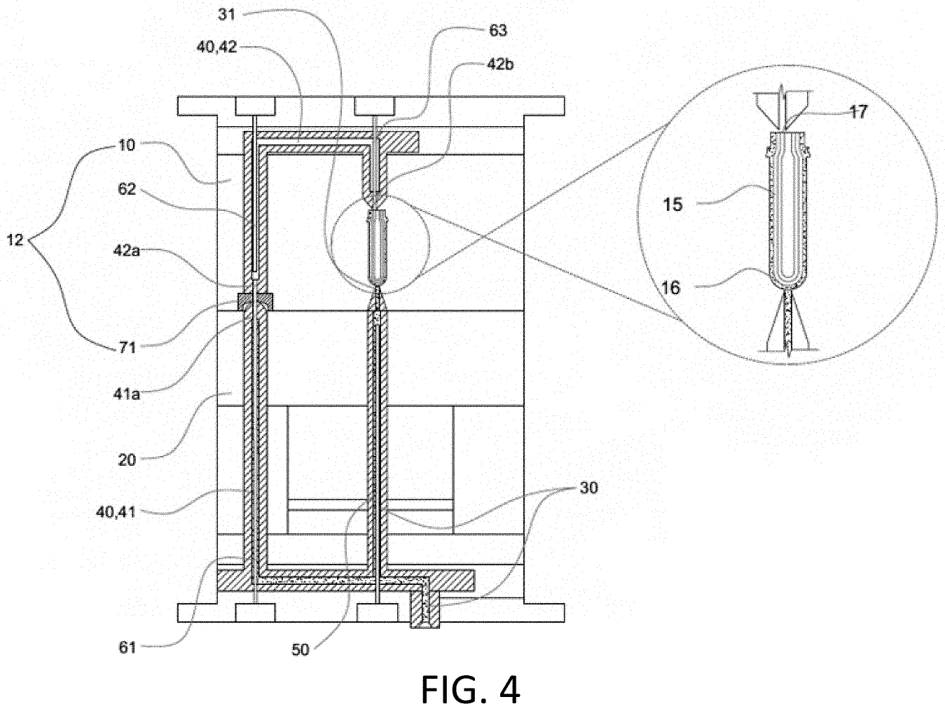

FIG. 4 illustrates a side sectional view of the first injection stage, according to an embodiment. In particular, FIG. 4 illustrates a side sectional view of the first injections stage where the control unit (not shown) may control the main closing and opening unit 50 to open the main runner 30 and the sub-closing and opening unit 60 to close the sub-runner 40. In one embodiment, the control unit may control the main valve pin 50 to open an outlet 31 of the main runner 30 and a first sub-valve pin 61 to close an outlet 41a of a first sub-runner 41 at the same time. Thus, in certain embodiments, the main runner 30 may feed the molten resin to the first cavity 16. Further, as illustrated in FIG. 4, the sub-runner 40 may include the first sub-runner 41 and a second sub-runner 42.

As further illustrated in FIG. 4, the second mold 20 may include the main runner 30, which feeds the molten resin to the first cavity 16. In addition, the main runner 30 may be a runner that feeds the molten resin to the first cavity 16, and the outlet of the main runner 30 may open into the first cavity 16. Furthermore, the sub-runner 40 may be branched from one side of the main runner 30, and include the first sub-runner 41. In certain embodiments, the first sub-runner 41 may be branched from the main runner 30 in the second mold 20 and a second sub-runner 42, which is formed in the first mold 10. In another embodiment, while the first sub-runner 41 is formed in the second mold 20, the second sub-runner 42 may be formed in the first mold 10, separately. However, in certain embodiments, the sub-runner 41 may be connected with the second sub-runner 42 when the first mold 10 and the second mold 20 close. As such, the mold may also be closed.

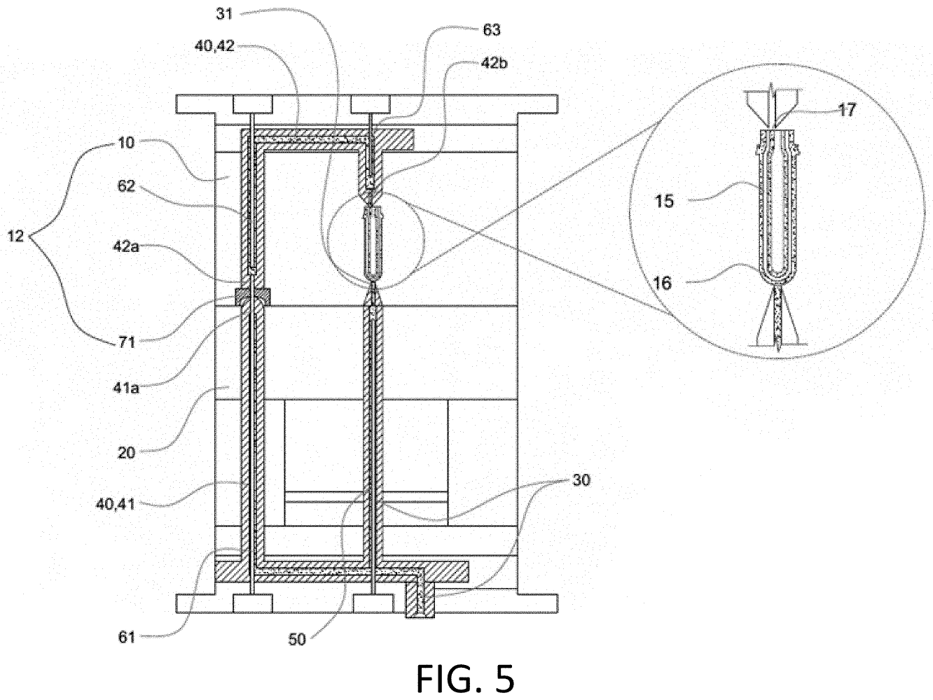

FIG. 5 illustrates a side sectional view of a second injection stage, according to an embodiment. In particular, FIG. 5 illustrates a second injection stage after the first injection stage set forth in FIG. 4. According to certain embodiments, in the second injection stage, the control unit may control the sub-closing and opening unit 60 to open the sub-runner 40. More specifically, the control unit may control the first sub-valve pin 61, the second sub-valve pin 62, and a third sub-valve pin 63 to open at the same time. As such, the sub-runner 40 may feed the molten resin to the second cavity 17.

FIG. 5 also illustrates the second injection stage of the hot runner apparatus, in which when the first mold 10 and the second mold 20 close, the outlet 41a of the first sub-runner 41 connects with an inlet 42a of the second sub-runner 42 with the help of locator 71. According to an embodiment, the locator 71 may be used (e.g., as a connector between two runners) when two runners connect in the mold. In addition, molten resin from the first sub-runner 41 may be fed into the second sub-runner 42, and then the outlet 42b of the second sub-runner 42 may feed the molten resin into the second cavity 17.

In certain embodiments, the main closing and opening unit (not shown) 50 may be operated by a main valve pin 50, which closes and opens the outlet 31 of the main runner 30. According to another embodiment, the main valve pin 50 may move back and forth, which closes and opens the outlet 31 of the main runner 30. In one embodiment, the sub-closing and opening unit 60 may include the first sub-valve pin 61, which closes and opens the first sub-runner 41, the second sub-valve pin 62 that closes and opens the inlet 42a of the second sub-runner 42, and the third sub-valve pin 63 that closes and opens the outlet 42b of the second sub-runner 42.

According to certain embodiments, the first mold 10 and the second mold 20 may close. When these two molds close, the first sub-valve pin 61 may open the outlet 41a of the first sub-runner 41, and then the molten resin in the first sub-runner 41 fed from the main runner 30 may be fed into the second sub-runner 42. According to one embodiment, the first sub-valve pin 61 may close the outlet 41a of the first sub-runner 41 when the first mold 10 and the second mold 20 open. As such, the molten resin cannot be ejected into the outside through the outlet 41a of the first sub-runner 41. When the first mold 10 and the second mold 20 close, the second sub-valve pin 62 may open the inlet 42a of the second sub-runner 42. Then the molten resin may be fed from the first sub-runner 41 into the second sub-runner 42.

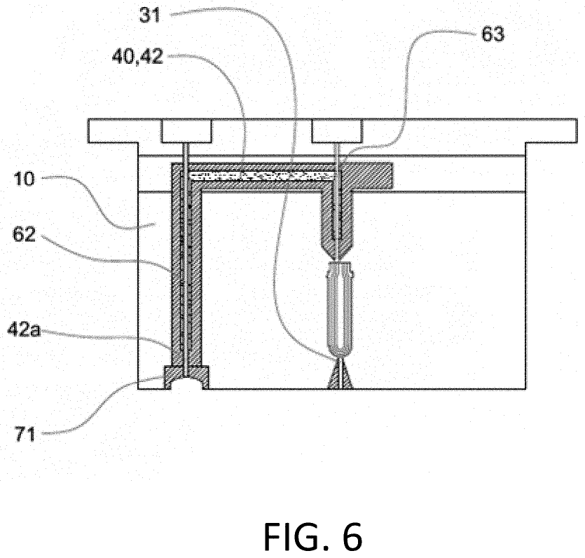

FIG. 6 illustrates a side sectional view of all three sub-valve pins in the closed position, according to an embodiment. Specifically, FIG. 6 illustrates a side sectional view of all three sub-valve pins closed when the first mold and the second mold open. Then, the molten resin in the sub-runners cannot be ejected in accordance with certain exemplary implementations of the present invention.

In addition, FIG. 6 illustrates that the second sub-valve pin 62 closes the inlet 42a of the second sub-runner 42 when the first mold 10 and the second mold 20 open. Then the molten resin in the second sub-runner 42 would not be able to be ejected through the inlet 42a of the second rub-runner 42. Further, when the first mold 10 and the second mold 20 close, the third sub-valve pin 63 may open the outlet 42b of the second sub-runner 42, which allows the molten resin in the second sub-runner 42 to be fed into the second cavity 17. FIG. 6 also illustrates that the third sub-valve pin 63 may close the outlet 42b of the second sub-runner 42 when the first mold 10 and the second mold 20 open. This may ensure that the molten resin in the second sub-runner 42 is not ejected through the outlet 42b of the second sub-runner 42.

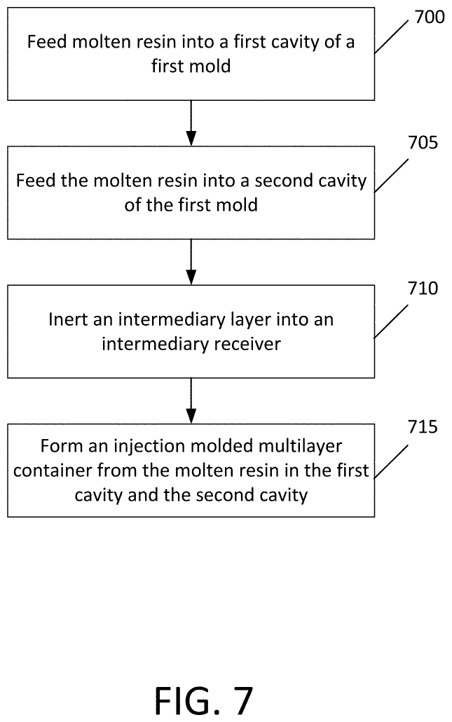

FIG. 7 illustrates a flow diagram of a method, according to an embodiment. In certain embodiments, the flow diagram may be performed by the hot runner apparatus described herein. The method may include, at 700, feeding molten resin into a first cavity of a first mold. The method may also include, at 705, feeding the molten resin into a second cavity of the first mold. In addition, the method may include, at 710, inserting an intermediary layer into an intermediary receiver. Further, the method may include, at 715, forming an injection molded multilayer container from the molten resin in the first cavity, the second cavity, and the intermediary receiver. In an embodiment, the molten resin may be fed into the first cavity through a main runner in a second mold. In another embodiment, the molten resin may be fed into the second cavity through connecting with a first sub-runner when both the first mold and the second mold close.

According to an embodiment, the method may also include opening and closing the first sub-runner via a first sub-valve pin, and opening and closing an inlet of the second sub-runner via a second sub-valve pin. In another embodiment, the method may include opening and closing an outlet of the second sub-runner via a third sub-valve pin. In a further embodiment, the method may include controlling the sub-closing and sub-opening unit via a control unit. In addition, according to an embodiment, the method may include controlling, by the control unit, the main closing and opening unit to open the runner by operation of the control unit. In another embodiment, the method may include controlling, by the control unit, the sub-closing and sub-opening unit to close the sub-runner when injecting the first outer layer. According to another embodiment, the method may include controlling the sub-closing and sub-opening unit to open the sub-runner when injecting a second inner layer.

Certain embodiments described herein provide several technical improvements, enhancements, and/or advantages. In some example embodiments, it may be possible to provide an injection molding apparatus capable of injection molding a multilayer article in which an intermediary layer of barrier resin is disposed between layers of the same kind of matrix resin. It may also be possible to create the multilayer article in a stable manner without employing conventional expensive multilayer injection machines that have multiple injection units. According to other embodiments, it may be possible to implement injection molding a multilayer article without unnecessarily wasting multiple injection units due to separate use of the main injection unit and the sub-injection unit, which have their own separate runners as fluid paths. In further embodiments, it may be possible to lower the cost of injection molding a multilayer article where the first outer layer and the second inner layer are of the same type of matrix resin.

One having ordinary skill in the art will readily understand that the invention as discussed above may be practiced with steps in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

We claim:

1. An apparatus for injection molding, comprising:
an injection unit;
a first mold comprising a first cavity to accommodate a first outer layer, a second cavity to accommodate a second inner layer, and an intermediary receiver to accommodate an intermediary layer;
a second mold;
a main runner configured to feed molten resin into the first cavity;
a sub-runner branched and connected from the main runner and feeds the molten resin to the second cavity;
a main closing and opening unit configured to close and open the main runner; and
a sub-closing and opening unit configured to close and open the sub-runner.

2. The apparatus according to claim 1,
wherein the sub-runner is branched from the main runner,
wherein the second sub-runner is connected separately from the first sub-runner,
wherein the second sub-runner is configured to feed the molten resin to the second cavity through a connection with the first sub-runner when both the first mold and the second mold are closed.

3. The apparatus according to claim 1,
further comprising a first sub-valve pin and a second sub-valve pin,
wherein the first sub-valve pin is configured to open and close an outlet of the first sub-runner, and
wherein the second sub-valve pin is configured to open and close an inlet of the second sub-runner.

4. The apparatus according to claim 1, further comprising a third sub-valve pin that is configured to open and close an outlet of the second sub-runner.

5. The apparatus according to claim 1, wherein the sub-closing and sub-opening unit is controlled by a control unit.

6. The apparatus according to claim 5, wherein the control unit is configured to
control the main closing and opening unit to open the main runner, and
control the sub-closing and sub-opening unit to close the sub-runner when injecting the first outer layer.

7. The apparatus according to claim 5, wherein the control unit is configured to
control the sub-closing and sub-opening unit to open the sub-runner when injecting the second inner layer.

8. A method for injection molding, comprising:
feeding molten resin into a first cavity of a first mold;
feeding the molten resin into a second cavity of the first mold;
inserting an intermediary layer into an intermediary receiver; and
forming an injection molded multilayer container from the molten resin in the first cavity, the second cavity, and the intermediary receiver,
wherein the molten resin is fed into the first cavity through a main runner in a second mold, and
wherein the molten resin is fed into the second cavity through connecting with a first sub-runner when both the first mold and the second mold are closed.

9. The method according to claim 8, further comprising:
opening and closing the first sub-runner via a first sub-valve pin; and
opening and closing an inlet of the second sub-runner via a second sub-valve pin.

10. The method according to claim 8, further comprising opening and closing an outlet of the second sub-runner via a third sub-valve pin.

11. The method according to claim 8, further comprising controlling the sub-closing and sub-opening unit via a control unit.

12. The method according to claim 11, further comprising:
controlling, by the control unit, the main closing and opening unit to open the runner by operation of the control unit; and
controlling, by the control unit, the sub-closing and sub-opening unit to close the sub-runner when injecting the first outer layer.

13. The method according to claim 11, further comprising controlling, by the control unit, the sub-closing and sub-opening unit to open the sub-runner when injecting a second inner layer.
